(19) United States
(12) Patent Application Publication
(10) Pub. No.: US 2014/0102457 A1
(43) Pub. Date: Apr. 17, 2014

(54) Apparatus to Limit the Spread of Infectious Material from a Cough or Sneeze

(71) Applicant: Eric Safieh, Toronto (CA)

(72) Inventor: Eric Safieh, Toronto (CA)

(21) Appl. No.: 13/649,219

(22) Filed: Oct. 11, 2012

(51) Int. Cl. A62B 23/00

(52) U.S. Cl. 128/205.29; 128/205.27

(57) ABSTRACT

An apparatus to limit the spread of infectious material from a cough or sneeze. The apparatus comprises a first liquid impermeable layer, a second absorbent layer, and a third permeable layer. The second absorbent layer has an upper surface, a lower surface and side surfaces. The third permeable layer is adjacent to the upper surface of the second absorbent layer. The first liquid impermeable layer encompasses the bottom and side surfaces of said second absorbent layer preventing the unintended escape of fluids or other material from or through the bottom and side surfaces of the second absorbent layer. The third permeable layer provides protection to the second absorbent layer and has a generally open structure to facilitate the passage of fluids therethrough and into the second absorbent layer. Liquids expelled through coughing or sneezing and captured by the third permeable layer are transferred to and retained by the second absorbent layer.

### FIELD

This invention relates generally to an apparatus that may be used to limit the spread of infectious materials that may be expelled through coughing or sneezing.

### BACKGROUND

It has been well documented that bacteria and viruses are commonly spread through the act of coughing and/or sneezing. A cough or a sneeze can be a relatively violent occurrence that can expel, at a considerable velocity, small droplets of fluid that may contain infectious materials. Many health organizations actively promote the covering of one's nose and mouth during coughing and sneezing as a means to limit the spread of bacteria and viruses. Traditionally, children were taught to cover their mouth with their hand when coughing or sneezing. However, it was quickly appreciated that doing so merely resulting in the deposition of potentially infectious material upon an individuals' hands, after which that material could be easily spread to other hard surfaces (for example light switches, doorknobs, faucet handles, etc.) and thereby passed from individual to individual. As an alternative, health organizations have promoted the practice of coughing or sneezing into one's sleeve or a tissue in order to better trap and contain any infectious material that may be expelled. While such a practice may be preferable to coughing or sneezing into one's hand, in the case of a tissue, the structure of the tissue is such that it cannot in many instances adequately contain high velocity droplets of fluid that may be expelled. Where one coughs or sneezes into his or her sleeve, expelled material may be caught and retained upon the sleeve, however, it may at that point then be transferred from the sleeve to other surfaces and passed from individual to individual. In many climates there is also a substantial portion of the year where individuals wear short sleeve or sleeveless shirts, making coughing or sneezing into a sleeve impossible.

### SUMMARY

In one aspects there is provided an apparatus to limit the spread of infectious material from a cough or sneeze, the apparatus comprising a first liquid impermeable layer; a second absorbent layer, said second absorbent layer having an upper surface, a lower surface and side surfaces; and, a third permeable layer positioned adjacent to the upper surface of said second absorbent layer, said first liquid impermeable layer encompassing the bottom and side surfaces of said second absorbent layer preventing the unintended escape of fluids or other material from or through the bottom and side surfaces of said second absorbent layer, said third permeable layer providing protection to said second absorbent layer and having a generally open structure to facilitate the passage of fluids therethrough and into said second absorbent layer, liquids expelled through coughing or sneezing and captured by said third permeable layer being transferred to and retained by said second absorbent layer.

In a further aspect there is provided an apparatus to limit the spread of infectious material from a cough or sneeze, the apparatus comprising a first liquid impermeable layer; and a second absorbent layer, said second absorbent layer having an upper surface, a lower surface and side surfaces, said first liquid impermeable layer encompassing the bottom and side surfaces of said second absorbent layer preventing the unintended escape of fluids or other material from or through the bottom and side surfaces of said second absorbent layer, said second absorbent layer capturing and retaining fluids and materials directed to said second absorbent layer through coughing or sneezing, said second absorbent layer compressible such that said apparatus can be compressed about the nose and mouth of an individual.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper side perspective view of an apparatus to limit the spread of infectious material from a cough or sneeze constructed in accordance with one of the preferred embodiments of the present invention.

FIG. 2 is a cross-sectional view taken along the line 2-2 of FIG. 1.

FIG. 3 is a cross-sectional view taken along the line 3-3 of FIG. 1.

FIG. 4 is a side view of the apparatus of FIG. 1 shown in a closed configuration.

FIG. 5 is an upper side perspective view of one embodiment of a containment vessel to contain the apparatus shown in FIG. 1.

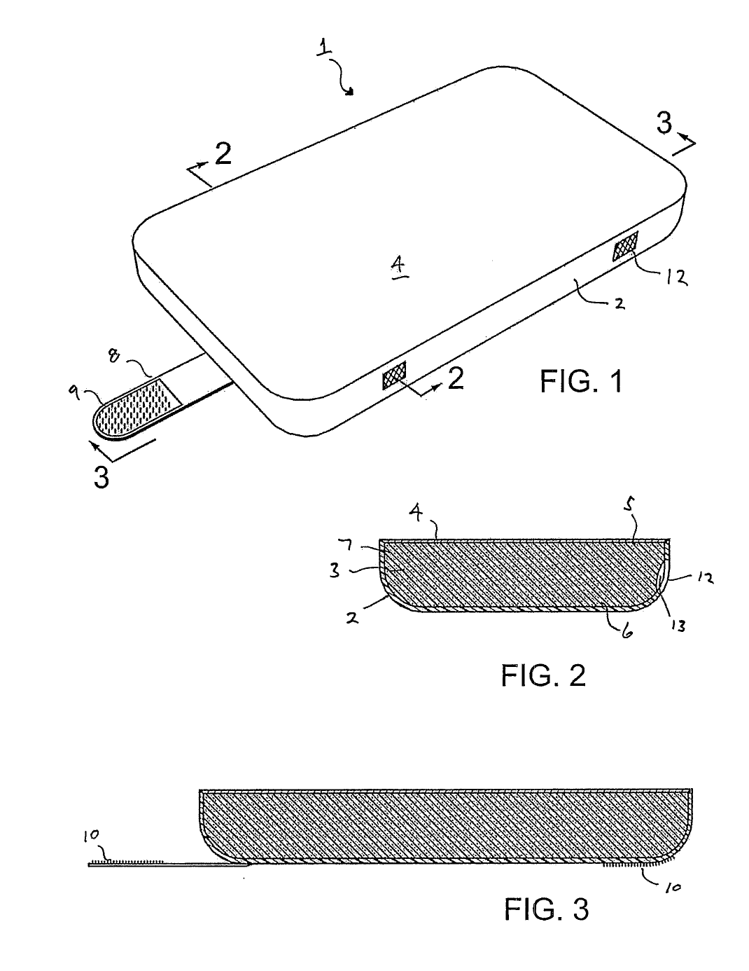

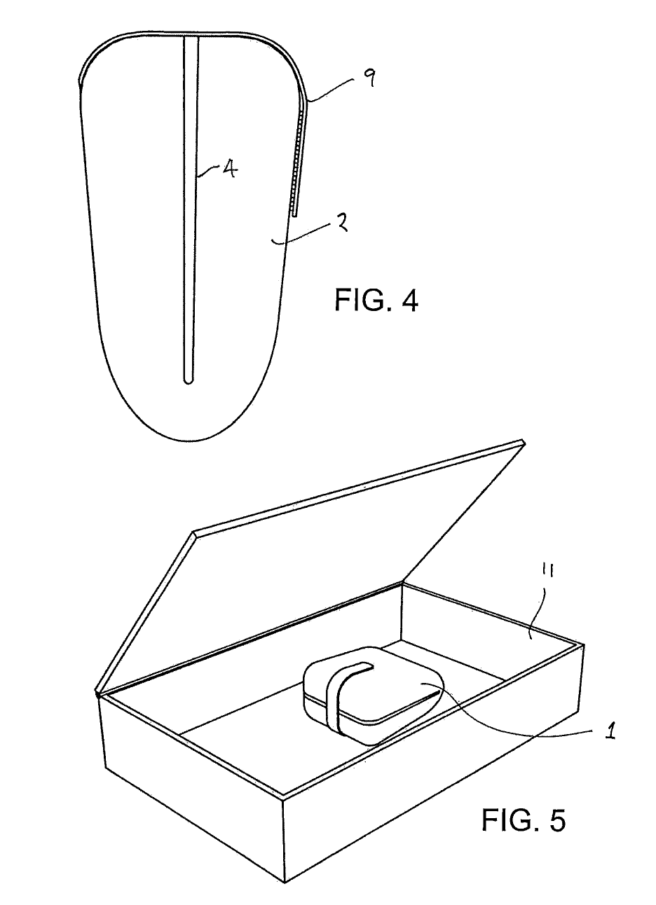

### DESCRIPTION

The present invention may be embodied in a number of different forms. The specification and drawings that follow describe and disclose some of the specific forms of the invention.

In the attached drawings there is shown an apparatus 1 to limit the spread of infectious material from a cough or a sneeze as constructed in accordance with one of the preferred embodiments of the invention. In one embodiment, apparatus 1 is comprised of a first liquid impermeable layer 2, a second absorbent layer 3 and a third permeable layer 4. Second absorbent layer 3 has an upper surface 5, a lower surface 6 and side surfaces 7. First liquid impermeable layer 2 encompasses the bottom and side surfaces of second absorbent layer 3 to prevent the escape of fluids or other material from or through the bottom or sides of the second absorbent layer. That is, in essence the second absorbent layer is encased by the first liquid impermeable layer along its bottom and side surfaces.

In the embodiment shown, third permeable layer 4 is positioned adjacent to the upper surface 5 of second absorbent layer 3. The permeable layer is secured to the upper surface of the absorbent layer, however, in alternate embodiments of the invention the permeable layer may instead be secured to the upper edges or sides of the first liquid impermeable layer such that it lays adjacent to the upper surface of the absorbent layer, but is not physically attached thereto. Third permeable layer 4 has an generally “open” structure to readily permit the passage of many of the fluids and materials expelled onto it into second absorbent layer 3. Preferably the permeable layer will exhibit wicking properties to draw moisture away from the layer and into second absorbent layer 3.

While it will be appreciated that a wide variety of structures and compositions can be utilized for purposes of forming third permeable layer 4, in one embodiment the layer is formed from non-woven polypropylene that is typically created through extruding or forcing melted polypropylene resin through small holes with the assistance of air pressure to create a relatively loose, highly permeable, fibre that is then bonded together into a generally open sheet-like structure. Such non-woven fabrics are commonly employed in applications where the wicking of moisture is desirable. Such materials also tend to be soft to the touch and will be advantageous for use in association with apparatus 1 as it will maximize comfort and present a smooth soft surface for applying against a user's mouth and nose.

As will be appreciate from a thorough understanding of the invention, and from an understanding of the nature and function of second absorbent layer 3, the function and purpose of third permeable layer 4 may vary from one embodiment of the invention to another. That is, the third permeable layer may be used to wick moisture and fluids deposited thereon into the second absorbent layer, may be used as a means to isolate the nose and mouth of a user from the second absorbent layer, may assist in retaining the second absorbent layer within the apparatus, may help to protect the second absorbent layer from abrasion or other damage, may provide a soft surface for placing against the face of a user, or may perform any combination of such functions.

Second absorbent layer 3 may be constructed from a very wide variety of different materials, and may also be a composite material formed from more than one individual material. Further, absorbent layer 3 may be a series of individual layers fastened together or simply positioned adjacent to one another and held in place by first impermeable layer 2 and third permeable layer 4. Since the primary object of the absorbent layer is to filter air from a cough or a sneeze and to retain fluids and infectious material that may be present, many suitable materials presently used for air filtration could be utilized for second absorbent layer 3. An example of some of the types of material that could be utilized can be found in US Patent Application Publication 2009/0320849, dated Dec. 31, 2009, United States Patent Application Publication 2011/0209711, dated Sep. 1, 2011 and United States Patent Application Publication 2010/015485, dated Jun. 24, 2010. Further, natural fibers such as cotton, could be used, however, it is expected in most instances a synthetic polymer-type material would be preferable as such materials typically exhibit an enhanced capacity to absorb liquids. Polymers that form a gel network that are not water soluble and that can absorb significant amounts of water, could also be used. Such polymers are often referred to as hydrogels, super absorbents, or hydrocolloids.

In an alternate embodiment, second absorbent layer 2 could be formed of or include sheep wool. Because of its crimped nature, sheep wool contains a relatively high number of tiny pockets and is capable of absorbing a significant amount of moisture without becoming wet to the touch. Wool therefore presents the ability to absorb moisture, yet retains the ability to stop or impede the flow of air from a subsequent cough or sneeze. Wool is also readily washable, whereas certain types of polymer absorbents or absorbent layers, may not be.

When apparatus 1 is subjected to a cough or sneeze, some of the liquid and other particles entrained within the cough or sneeze will pass directly through third permeable layer 4 and will bombard directly upon the fibres at or near the surface of second absorbent layer 3, where they will be stopped and trapped. It is expected that particles generally greater than 0.1 microns will be trapped by fibers either through direct impact and collision, and/or by interception through proximity and electrostatic or electrostatic-like mechanisms. Smaller particles may defuse through the outer portions of second absorbent layer 3. However, as their rate of movement decelerates while moving through the absorbent layer, they will be stopped and retained by fibers positioned more deeply within the interior of the absorbent layer. Second absorbent layer 3 may also be formed from a plurality of different fibers that are designed to introduce opposite electrostatic charges in the fabric as a means to help attract small droplets of fluid and other materials in the cough or sneeze.

Depending upon the nature of the material or materials used to construct second absorbent layer 3, the physical structure of the layer may vary. In one embodiment the layer may take a form of a mass of randomly oriented fibers. In an alternate embodiment the absorbent layer could be in a pleated form. In a further embodiment the layer may be in the form of a labyrinth of passages and chambers that receive and help to decelerate air and entrained fluids and other materials expelled during a cough or sneeze. The second absorbent layer may also be compressible to permit apparatus 1 to be compressed about the nose or mouth of an individual when in use. Further, second absorbent layer 3 may be releaseably secured to first impermeable layer 2, allowing the absorbent layer to be discarded or washed and replaced. Where the third permeable layer is affixed to the edges of first liquid impermeable layer 2, at least one edge of the junctures of the two layers would be releaseably securable to allow an “opening” of the apparatus to permit the absorbent layer to be inserted and/or removed. Where third permeable layer 4 is physically secured to the upper surface of the absorbent layer, both the absorbent layer and the permeable layer would be removed from the liquid impermeable layer and either washed or discarded. In such a case the absorbent layer would be secured to the first impermeable layer, through use of a fastener (or example, a hook and loop fastener), through use of an adhesive, through sewing, etc. Second absorbent layer 3 and/or third permeable layer 4 may also include one or more anti-viral or anti-bacterial agents.

In still a further embodiment of the invention third permeable layer 4 may be dispensed with. In this embodiment the apparatus will essentially comprise first impermeable layer 2 and second absorbent layer 3. Here the absorbent layer would be releasably or permanently attached to the impermeable layer.

It will also be appreciated that first liquid impermeable layer 2 may equally be formed from a very wide range of different materials. One of the primary functions of the first liquid impermeable layer is to contain liquid and potentially infectious materials that may be deposited on or into either the second or third layers. To that end, first liquid impermeable layer could be formed from a vinyl, polyurethane, polyolefin, polyethylene, or any one of a variety of other similar types of materials. The first impermeable layer may also be a polymeric material that is applied to the second layer by spraying or dipping.

In an embodiment of the invention, apparatus 1 may be folded upon itself with second absorbent layer 3 and third permeable layer 4 essentially encased and surrounded by first liquid impermeable layer 2 (see FIG. 4). In this manner, any liquid or infectious material that may be retained on or received in the absorbent or permeable layers would be effectively contained within the impermeable layer and protected from coming into contact with other individuals or objects. In order to retain the apparatus in such a folded configuration, first impermeable layer 2 may include a fastener 8. It will be appreciated that the fastener may take any one of a wide variety of different structures including a snap, buckle, or hook and loop fastener. In the embodiment shown in FIG. 4, the fastener comprises a strap 9 secured in place through use of a hook and loop fastener 10.

In a further embodiment of the invention there is included a containment vessel 11 that is dimensioned to receive apparatus 1 therein. The containment vessel will generally include enclosed side and bottom surfaces with an open and closable lid or top that will help prevent the escape of infectious material that may be contained on or within apparatus 1 when it is received within the containment vessel.

It may also be desirable in some instances to include one or more vents 12 within first liquid impermeable layer 2. Vents 12 will facilitate in the release of air directed into the second absorbent layer once that air has been filtered by the absorbent layer to remove infectious and/or other material that may be present. Vents 12 may include filter media 13 positioned therein to provide a further and enhanced level of filtering of any air that may be allowed to escape therethrough. As in the case of the absorbent and permeable layer, filter media 13 may include or be treated with anti-viral or anti-bacterial agents.

It will therefore be appreciated from a thorough understanding of the invention that apparatus 1 presents a structure that an individual may place close to or over his or her nose or mouth during a cough or sneeze in order to capture and help prevent the spread of infectious material. The apparatus is relatively small, lightweight and portable such that it can be easily carried from place to place. When not in use, the apparatus may be folded and retained in a closed configuration, not only facilitating its storage and transport, but also helping to further prevent the unintended release of potentially infectious material.

It is to be understood that what has been described are the preferred embodiments of the invention. The scope of the claims should not be limited by the preferred embodiments set forth above, but should be given the broadest interpretation consistent with the description as a whole.

I claim:

1. An apparatus to limit the spread of infectious material from a cough or sneeze, the apparatus comprising:
a first liquid impermeable layer;
a second absorbent layer, said second absorbent layer having an upper surface, a lower surface and side surfaces; and,
a third permeable layer positioned adjacent to the upper surface of said second absorbent layer,
said first liquid impermeable layer encompassing the bottom and side surfaces of said second absorbent layer preventing the unintended escape of fluids or other material from or through the bottom and side surfaces of said second absorbent layer,
said third permeable layer providing protection to said second absorbent layer and having a generally open structure to facilitate the passage of fluids therethrough and into said second absorbent layer, liquids expelled through coughing or sneezing and captured by said third permeable layer being transferred to and retained by said second absorbent layer.

2. The apparatus as claimed in claim 1 wherein said second absorbent layer is compressible such that said apparatus can be compressed about the nose and mouth of an individual.

3. The apparatus as claimed in claim 2 wherein said second absorbent layer and/or said third permeable layer include one or more anti-viral or anti-bacterial agents.

4. The apparatus as claimed in claim 2 wherein said second absorbent layer is releasably secured to said first liquid impermeable layer.

5. The apparatus as claimed in claim 1 wherein said liquid impermeable layer includes a fastener, said apparatus foldable upon itself with said second absorbent and said third permeable layers encased and surrounded by said first liquid permeable layer, when so folded said fastener retaining said apparatus in a folded configuration.

6. The apparatus as claimed in claim 5 wherein said fastener is a snap, buckle or hook and loop fastener.

7. The apparatus as claimed in claim 1 further including a containment vessel, said containment vessel dimensioned for the receipt of said apparatus therein, said containment vessel including enclosed side and bottom surfaces and a closable lid to help prevent the escape of infectious material that may be contained on or within said apparatus.

8. The apparatus as claimed in claim 5 wherein said second absorbent layer is of a labyrinth construction including a plurality of chambers and passageways to receive and decelerate air, entrained fluid and other materials expelled during a cough or sneeze.

9. The apparatus as claimed in claim 1 wherein said first liquid impermeable layer includes one or more vents therethrough to allow for the escape of air directed into said second absorbent layer during a cough or a sneeze, said air filtered by said second absorbent layer to remove infectious material that may be present prior to being released through said one or more vents.

10. The apparatus as claimed in claim 9 wherein said one or more vents include filter media to help prevent the escape of infectious material therethrough.

11. The apparatus as claimed in claim 10 wherein said filter media includes one or more anti-viral or anti-bacterial agents.

12. An apparatus to limit the spread of infectious material from a cough or sneeze, the apparatus comprising:
a first liquid impermeable layer; and
a second absorbent layer, said second absorbent layer having an upper surface, a lower surface and side surfaces,
said first liquid impermeable layer encompassing the bottom and side surfaces of said second absorbent layer preventing the unintended escape of fluids or other material from or through the bottom and side surfaces of said second absorbent layer,
said second absorbent layer capturing and retaining fluids and materials directed to said second absorbent layer through coughing or sneezing, said second absorbent layer compressible such that said apparatus can be compressed about the nose and mouth of an individual.

13. The apparatus as claimed in claim 12 wherein said second absorbent layer is releasably secured to said first liquid impermeable layer.

14. The apparatus as claimed in claim 12 wherein said liquid impermeable layer includes a fastener, said apparatus foldable upon itself with said second absorbent layer encased and surrounded by said first liquid permeable layer, when so folded said fastener retaining said apparatus in a folded configuration.

15. The apparatus as claimed in claim 14 wherein said first liquid impermeable layer includes one or more vents therethrough to allow for the escape of air directed into said second absorbent layer during a cough or a sneeze, said air filtered by said second absorbent layer to remove infectious material that may be present prior to being released through said one or more vents.

16. The apparatus as claimed in claim 15 wherein said one or more vents include filter media to help prevent the escape of infectious material therethrough.

17. The apparatus as claimed in claim 16 wherein said filter media includes an anti-viral or anti-bacterial agent.
